(19) United States
(12) Patent Application Publication
(10) Pub. No.: US 2025/0165911 A1
(43) Pub. Date: May 22, 2025

(54) METHOD AND DEVICE FOR FORECASTING DELIVERY FARE AND DETERMINING BATCHING POSSIBILITY PREDICTION-BASED DYNAMIC DISCOUNT FOR SCHEDULED ORDER OF GOODS DELIVERY SERVICE

(71) Applicant: GRABTAXI HOLDINGS PTE. LTD., Singapore (SG)

(72) Inventors: Xueheng QIU, Singapore (SG); Renrong WENG, Singapore (SG)

(21) Appl. No.: 18/839,093

(22) PCT Filed: Mar. 21, 2023
(86) PCT No.: PCT/SG2023/050181

§ 371 Date: Aug. 16, 2024

(30) Foreign Application Priority Data
Apr. 22, 2022 (SG) 10202204250S

(51) Int. Cl. G06Q 10/0834; G06Q 30/0235; G06Q 30/0283

(52) U.S. Cl. CPC G06Q 10/08345; G06Q 30/0235; G06Q 30/0283

(57) ABSTRACT

Aspects concern a method for forecasting a delivery fare and determining a batching possibility prediction-based dynamic discount for a scheduled order of a goods delivery service, the method including predicting a delivery fare for a scheduled delivery in an available time slot, and predicting a batching rate for the scheduled delivery to be batched with at least one other order in the available time slot. The method further includes determining a discount for the scheduled delivery in the available time slot, based on the predicted batching rate, determining a final delivery fare for the scheduled delivery in the available time slot, based on the predicted delivery fare and the determined discount, and displaying the determined final delivery fare for user selection of the scheduled delivery.

### TECHNICAL FIELD

Various aspects of this disclosure relate to methods and devices for forecasting a delivery fare and determining a batching possibility prediction-based dynamic discount for a scheduled order of a goods delivery service.

### BACKGROUND

A scheduled delivery is a service delivery that is provided to a customer who might not need the service delivery urgently, and offers more flexibility for the customer to schedule the service delivery in advance. For example, the customer may order the scheduled delivery for his dinner or a grocery delivery when he is on the way home.

A customer may be allowed to order scheduled deliveries for up to weeks, as within each day there may be multiple delivery time slots available. Delivery fares can be computed for multiple time slots simultaneously, not just for a single time slot. There are some concerns to be taken into consideration when computing the delivery fares. First, a delivery fare computed at a given time slot should not deviate too far away from a delivery fare of a real time order at the same time slot. This is to avoid customer gaming behaviour. Also, the customer should be encouraged to make orders at non-peak hours as much as possible, so that delivery drivers are fully utilized when they are less occupied. Further, the customer should be nudged to make orders at certain time slots, so that an order batching rate may be boosted to improve network efficiency.

However, there are some challenges that come along with the above concerns. First, delivery fares for real time orders may need to be forecasted several days ahead. A prediction accuracy of these delivery fares is a big challenge as real time signals for understanding market conditions may not be available. Also, a discount mechanism may need to be designed on top of the fare forecasting, which may be quite complicated.

To address the above challenges, a naive approach may be to assume a future delivery fare and a batching rate are identical or very close to their historical distributions, to thus calculate mean values of the future delivery fare and batching rate in a certain area and a certain time slot, and to give a discount based on the calculated mean values. However, performance of this discount can heavily rely on forecasting accuracy, which may not be satisfied by the naive approach.

### SUMMARY

Various embodiments concern a method for forecasting a delivery fare and determining a batching possibility prediction-based dynamic discount for a scheduled order of a goods delivery service, the method including predicting a delivery fare for a scheduled delivery in an available time slot, and predicting a batching rate for the scheduled delivery to be batched with at least one other order in the available time slot. The method further includes determining a discount for the scheduled delivery in the available time slot, based on the predicted batching rate, determining a final delivery fare for the scheduled delivery in the available time slot, based on the predicted delivery fare and the determined discount, and displaying the determined final delivery fare for user selection of the scheduled delivery.

The predicting the delivery fare may include obtaining coordinates of an origin for the scheduled delivery, coordinates of a destination for the scheduled delivery, the available time slot, a base fare or tier base fare for the scheduled delivery, and a surge rate range, and predicting the delivery fare for the scheduled delivery in the available time slot, based on the obtained coordinates of the origin, the obtained coordinates of the destination, the obtained available time slot, the obtained base fare or tier base fare and the obtained surge rate range.

The delivery fare may be predicted using at least one among quantile regression, linear regression, lasso regression, support vector regression, a multilayer perceptron neural network, a long short-term memory neural network, and a decision tree-based algorithm.

Each of the quantile regression neural networks may include a multiple hidden layer feedforward neural network that is trained with historical data and a quantile loss.

The predicting the batching rate may include obtaining coordinates of an origin for the scheduled delivery, coordinates of a destination for the scheduled delivery, the available time slot, a number of completed orders in an area of the scheduled delivery and during the same time slot as the available time slot in prior week(s), and a batching rate of the completed orders, and predicting the batching rate for the scheduled delivery to be batched with the at least one other order in the available time slot, based on the obtained coordinates of the origin, the obtained coordinates of the destination, the obtained available time slot, the obtained number of the completed orders and the obtained batching rate of the completed orders.

The predicting the batching rate may further include determining a bearing for the scheduled delivery, the bearing representing a direction between the origin and the destination for the scheduled delivery, and the batching rate for the scheduled delivery to be batched with the at least one other order in the available time slot may be predicted further based on the determined bearing.

The predicting the batching rate may further include determining the number of the completed orders in the area of the scheduled delivery, having the determined bearing, and during the same time slot as the available time slot in the prior week, and determining the batching rate of the completed orders. The batching rate for the scheduled delivery to be batched with the at least one other order in the available time slot may be predicted further based on the determined number of the completed orders and the determined batching rate of the completed orders.

The predicted batching rate may be low, based on the available time slot including non-peak hours, and the predicted batching rate may be high, based on the available time slot including peak hours.

The batching rate may be predicted using a neural network with long short-term memory (LSTM) layers that is trained with historical data.

The determining the discount may include obtaining the predicted batching rate, coordinates of an origin for the scheduled delivery, coordinates of a destination for the scheduled delivery, the available time slot, a distance of the scheduled delivery, and a duration of the scheduled delivery, and determining the discount for the scheduled delivery in the available time slot, based on the obtained predicted batching rate, the obtained coordinates of the origin, the obtained coordinates of the destination, the obtained available time slot, the obtained distance of the scheduled delivery, and the obtained duration of the scheduled delivery.

The discount may be determined using an S-shaped sigmoid function having the predicted batching rate as an input and the discount as an output.

The S-shaped sigmoid function may include discount=a/b+exp^{-(BR-d)}+e, where a, b, c, d and e are coefficients and BR is the predicted batching rate.

Each of the coefficients a, b, c, d and e may be a function of a length of the available time slot.

The determined discount may be small, based on the available time slot being short, and the determined discount may be large, based on the available time slot being long.

The determined discount may be a preset minimum value, based on the predicted batching rate being less than a predetermined minimum value, and the determined discount may be a preset maximum value, based on the predicted batching rate being greater than or equal to a predetermined maximum value.

The final delivery fare may be determined using an equation including Final Fare=Predicted Fare*(1−Discount), where Predicted Fare is the predicted delivery fare, and Discount is the determined discount.

The determined final delivery fare may be displayed with the available time slot on a display, and is highlighted when selected by a user.

A server may be configured to perform the method.

A computer program element may include program instructions, which, when executed by one or more processors, cause the one or more processors to perform the method.

A computer-readable medium may include program instructions, which, when executed by one or more processors, cause the one or more processors to perform the method.

### BRIEF DESCRIPTION OF THE DRAWINGS

The invention will be better understood with reference to the detailed description when considered in conjunction with the non-limiting examples and the accompanying drawings, in which:

FIG. 1 shows a diagram illustrating a communication arrangement for usage of a goods delivery service, including a smartphone and a server;

FIG. 2 shows a block diagram of an architecture for forecasting a delivery fare and determining a batching possibility prediction-based dynamic discount for a scheduled order of a goods delivery service, according to embodiments;

FIG. 3 shows a graph illustrating mapping functions between an input predicted batching rate and an output discount, according to embodiments;

FIG. 4 shows a flow diagram of a method for forecasting a delivery fare and determining a batching possibility prediction-based dynamic discount for a scheduled order of a goods delivery service, according to embodiments; and

FIG. 5 shows a block diagram of the server of FIG. 1, implementing the architecture of FIG. 2.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

A goods delivery app, typically used on a smartphone, allows its user to order a delivery of goods (e.g., food and/or parcels) through his or her smartphone.

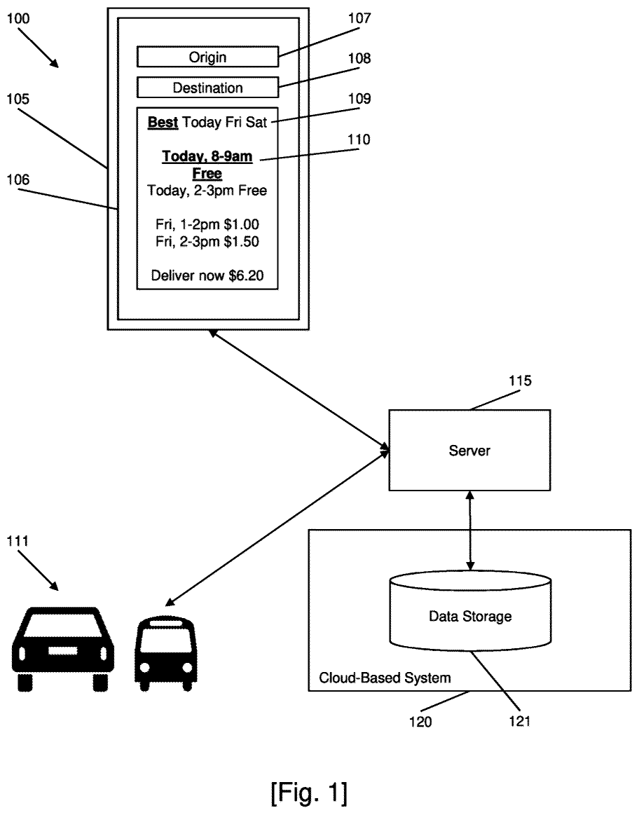

FIG. 1 shows a diagram of a communication arrangement 100 for usage of a goods delivery service, including a smartphone 105 and a server 115 (computer).

The goods delivery service may provide a delivery of goods that may include, for example, food, parcels, groceries, etc.

The smartphone 105 includes a screen showing a graphical user interface (GUI) 106 of a goods delivery app that a user of the smartphone 105 previously installed on his or her smartphone and opened or started to order a delivery of goods.

The GUI 106 includes a box for an origin 107 of the delivery of the goods, which the user may touch to enter the origin 107, e.g., opening a list of possible origins including, for example, a grocery store and/or a restaurant. The GUI 106 also includes a box for a destination 108 of the delivery of the goods, which the user can touch to enter the destination 108, e.g., opening a list of possible destinations including, for example, a home or office of the user. There may further be a menu (not shown) allowing the user to select various options, e.g., how to pay (cash, credit card, credit balance of the goods delivery service). When the user selects the destination, the GUI 106 shows a list of selectable days 109 on which the delivery of the goods can be scheduled, and a list of selectable time slots 110 during which the delivery of the goods can be scheduled. A delivery fare for each of the selectable time slots 110 is determined and displayed, as detailed below. In this example, “best” is selected from the list of the selectable days 109, and “Today, 8-9 am Free” is selected from the list of the selectable time slots 110, as highlighted in FIG. 1. Once one of the selectable time slots 110 is selected, the order for the delivery of the goods may be initiated by transmitting the order from the smartphone 105 to the server 115 of the goods delivery service.

For the above, the goods delivery app communicates with the server 115 of the goods delivery service via a radio connection. The server 115 may consult a memory of the server 115 or a data storage 121 storing information of current locations of registered delivery vehicles 111, of when they are expected to be free, of traffic jams, etc. From this, a processor of the server 115 selects the most suitable vehicle (if available, i.e., if the order can be fulfilled) and can provide an estimate of time when the vehicle will be at the origin 107 to pick up the goods, a price of the delivery of the goods and how long it will take to get to the destination 108. The server 115 communicates this back to the smartphone 105, and the smartphone 105 may display this information on the GUI 106. The user can then accept (i.e., schedule the order) by touching a corresponding button. If the user accepts, the server 115 informs a selected one among the vehicles 111 (or, equivalently, its driver), i.e., the vehicle the server 115 allocated for fulfilling the delivery of the goods.

It should be noted while the server 115 is described as a single server, its functionality (e.g., for providing the goods delivery service for a whole city) will in practical application typically be provided by an arrangement of multiple server computers (e.g., implementing a cloud service). Accordingly, functionalities described in the following provided by the server 115 may be understood to be provided by an arrangement of servers or server computers.

The data storage 121 may, for example, be part of a cloud-based system 120 provided by a cloud storage provider to store and access data, which it may use for taking decisions, such as information of locations of origins, destinations and vehicles, their history (earlier bookings and routes taken), etc.

The server 115 together with the vehicles 111 provide the goods delivery service. It should be noted that while the example of FIG. 1 relates to the goods delivery service where goods are transported and delivered, a transport system providing a transport service for transporting people may similarly be provided.

When the user makes the booking for delivery of the goods, the server 115 may provide the smartphone 105 with an estimate of time when the delivery of the goods will be completed, e.g., when the goods will be delivered to the user.

Embodiments described herein include a hybrid dynamic discount system for a scheduled order of a goods delivery service. First, the embodiments may capture long-term trends of a delivery fare, using a quantile regression model as a convenient tool to adjust a prediction of the delivery fare with a manner of proportionality and reasonableness. Also, the embodiments can accurately predict a batching possibility of the scheduled order, and provide a dynamic discount for the scheduled order, based on the predicted batching possibility.

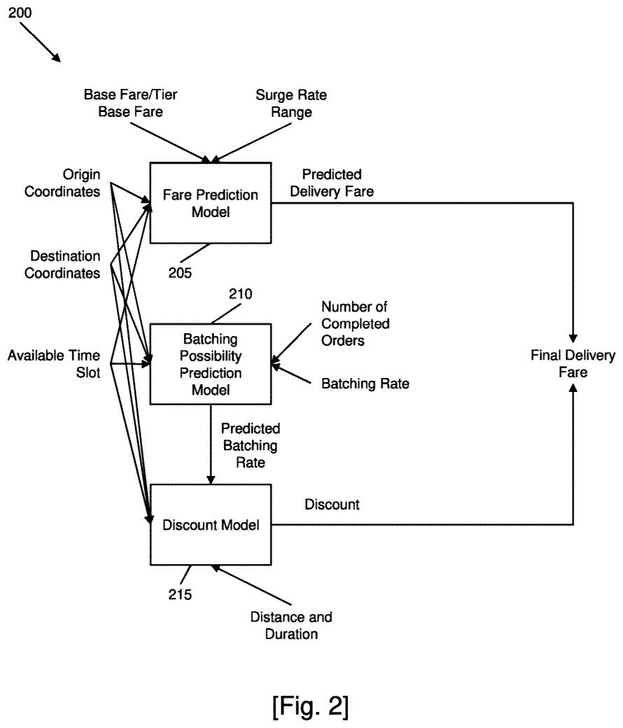

FIG. 2 shows a block diagram of an architecture 200 for forecasting a delivery fare and determining a batching possibility prediction-based dynamic discount for a scheduled order of a goods delivery service, according to embodiments.

Referring to FIG. 2, the architecture 200 includes a fare prediction model 205, a batching possibility prediction model 210 and a discount model 215.

In the goods delivery service, a user may be able to request or order an as soon as possible (ASAP) delivery or a scheduled delivery. The scheduled delivery can include a same day delivery in advance or a future delivery that is days in advance. The schedule delivery may also have a longer delivery time slot (period) than the ASAP delivery.

When the user is ordering a scheduled delivery of goods, the goods delivery service may need to provide, via a goods delivery app, a delivery fare and a discount (rate) for each available time slot, e.g., as shown in the GUI 106 of FIG. 1. The architecture 200 provides a final delivery fare for each available time slot, based on the delivery fare and the discount for each available time slot.

At a high level, the architecture 200 may determine the final delivery fare for the scheduled delivery in an available time slot by performing at least the following operations. First, the architecture 200 may predict a delivery fare for the scheduled delivery in the available time slot. Next, the architecture 200 may predict a batching rate for the scheduled delivery in the available time slot. Then, the architecture 200 may determine a discount for the scheduled delivery in the available time slot, based on the predicted batching rate. Finally, the architecture 200 may determine the final delivery fare, based on the predicted delivery fare and the determined discount, and may display the determined final delivery fare for user selection of the scheduled delivery.

In detail, the fare prediction model 205 obtains coordinates (e.g., latitude and longitude) of an origin (e.g., a merchant) for the scheduled delivery, coordinates (e.g., latitude and longitude) of a destination for the scheduled delivery, an available time slot (a day of a week, an hour and a minute of the day) for the scheduled delivery, a base fare or tier base fare for the scheduled delivery, and a surge rate range (between minimum and maximum surge rates). The fare prediction model 205 may further obtain or determine a distance of the scheduled delivery, a duration of the scheduled delivery, a merchant type of the origin for the scheduled delivery, a merchant surcharge of the origin for the scheduled delivery, a volume and a weight of the scheduled delivery, forecasting weather information at the available time slot, and/or whether the available time slot is a public holiday. Based on these obtained features, the fare prediction model 205 predicts or forecasts a long-term delivery fare for the scheduled delivery in the available time slot.

In examples, the longer the distance and/or the duration of the scheduled delivery is, the higher the predicted delivery fare is. During lunch or dinner peak hours, the surge rate may be high, and thus, the predicted delivery fare is also high. Some merchant types may add the merchant surcharge or a discount for all bookings made, which is considered in the prediction of the delivery fare.

Also, the fare prediction model 205 may include, but is not limited to, multiple quantile regression neural networks providing a series of forecasting results with different quantiles, which may be used as a convenient tool to adjust forecasting performance. Each of the quantile regression neural networks can include a multiple hidden layer feedforward neural network that is trained with historical data and a quantile loss. Quantile regression may be used as a convenient tool to adjust the predicted delivery fare higher or lower totally, with a manner both proportional and reasonable, if needed. In this example, a quantile value of 0.5 can be used to perform normal prediction. The delivery fare can also be predicted using, for example, various regression methods (e.g., linear regression, lasso regression, support vector regression, quantile regression, etc.), various neural networks (e.g., multilayer perceptron, LSTM, etc.), and/or decision tree-based algorithms (e.g., XGBoost, LightGBM, etc.).

The batching possibility prediction model 210 obtains the coordinates of the origin for the scheduled delivery, the coordinates of the destination for the scheduled delivery, the available time slot for the scheduled delivery, a number of completed orders in an area of the scheduled delivery and during the same time slot as the available time slot in prior week(s), and a batching rate (percentage) of the completed orders. Based on these obtained features, the batching possibility prediction model 210 predicts a batching rate (possibility percentage) for the scheduled delivery to be batched with at least one other order in the available time slot.

Also, the batching possibility prediction model 210 may determine a bearing for the scheduled delivery, which represents a direction between the origin and the destination for the scheduled delivery, and may use the determined bearing as one of the most important factors for predicting the batching rate for the scheduled delivery. For example, the batching possibility prediction model 210 may determine the number of the completed orders in the area of the scheduled delivery, having the determined bearing, and during the same time slot as the available time slot in the prior week, and determine the batching rate of the completed orders. The batching possibility prediction model 210 may use these determined features to predict the batching rate for the scheduled delivery in the available time slot.

Further, the batching possibility prediction model 210 may include a neural network with multiple long short-term memory (LSTM) layers to deal with time series features and to thus provide accurate batch possibility prediction results. The neural network with the multiple LSTM layers may be trained with historical data.

The features that are used to predict the batching rate for the scheduled delivery may be composed of two parts: (1) time series (TS) features; and (2) non-TS features. The TS features may include both the number of the completed orders, and the batching rate of the completed orders. In summary, historical data of a previous one week within the same time slot may be used as the TS features. The non-TS features can include both geographic and calendar information, including the coordinates of the origin for the scheduled delivery, the coordinates of the destination for the scheduled delivery, and the available time slot. For the neural network, the TS features may be analyzed by the LSTM layers first, then merged with the non-TS features to train a classifier.

For non-peak hours or time slots, demand may be low (e.g., historical data indicating that the number of completed orders is low), meaning the predicted batching rate may be determined to be low. During peak hours or time slots, due to high demand (e.g., the historical data indicating that the number of completed orders is high), the predicted batching rate may be determined to be high.

The discount model 215 obtains the predicted batching rate for the scheduled delivery in the available time slot, the coordinates of the origin or the location of the delivery vehicle for the scheduled delivery, the coordinates of the destination or the user for the scheduled delivery, the available time slot for the scheduled delivery, the distance of the scheduled delivery, and the duration of the scheduled delivery. The discount model 215 may further obtain a lead time of the scheduled delivery (a time difference between a current fare and/or discount time and a scheduled delivery time) and a remaining capacity of the available time slot. Based on these obtained features, the discount model 215 determines a discount (rate or percentage) for the scheduled delivery in the available time slot.

The determined discount for same day deliveries may be moderate for non-peak hours, and may be high for peak hours. However, a surge rate can also be high during peak hours, so a final delivery fare can still be higher than that determined within non-peak hours. Advantageously, a number of same day delivery orders may be increased, while shifting demand to non-peak hours.

The determined discount may monotonically increase with the predicted batching rate to provide the discount to a scheduled delivery order with a high possibility to be batched within the available time slot. The discount model 215 can use an S-shaped sigmoid function to accomplish a mapping function between the input predicted batching rate and the output discount, with tunable parameters for further optimisation. For example, the discount may be calculated based on the predicted batching rate, using the following sigmoid function:

$$discount = \frac{a}{b + {exp}^{- c ( BR - d )}} + e , \qquad ( 1 )$$

where a, b, c, d and e are coefficients and BR is the predicted batching rate.

Also, to encourage the user to choose a longer delivery time slot to further improve the goods delivery service, a larger discount may be provided for scheduled deliveries with longer delivery time windows. Thus, in an example, each of the coefficients a, b, c, d and e can be a function of a possible time window (that may be selected by the user) as follows:

$$\begin{matrix}a = \frac{0.5}{log ( 20 )} * log ( time window * 3 ) ; \\ b = 1 ; \\ c = 20 - log ( time window * 2 ) ; \\ d = 0.6 ; and \\ e = 0. 005 * log ( time window * 2 ) .\end{matrix} \qquad ( 2 )$$

Further, when the predicted batching rate is low (e.g., less than 0.3), a close-to-minimum discount may be offered. For scheduled deliveries within the same time slot, discounts can level off after the predicted batching rate reaches a predetermined high threshold, e.g., is greater than or equal to 0.8.

Moreover, a range of the discount may be from 0 to 0.5. Alternatively, the range may be preset via gamma, and the determined discount may be linearly mapped to a final discount within the preset range. The range may include absolute minimum and maximum values, or minimum and maximum percentage values.

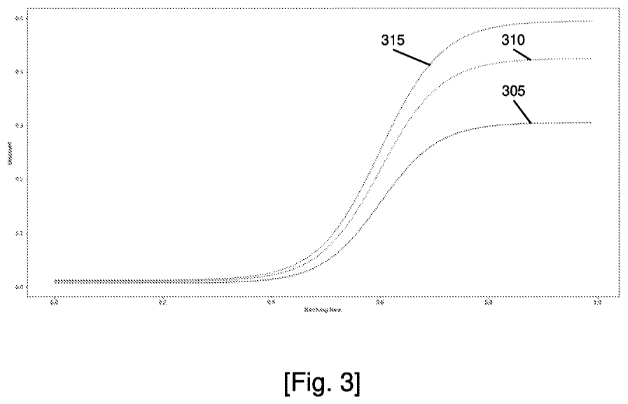

FIG. 3 shows a graph illustrating mapping functions 305, 310 and 315 between an input predicted batching rate and an output discount, according to embodiments.

Referring to FIG. 3, the mapping function 305 is for a time slot having a 2-hour duration, the mapping function 310 is for a time slot having a 4-hour duration and the mapping function 315 is for a time slot having a 6-hour duration. Each of the mapping functions 305, 310 and 315 is an S-shaped sigmoid function in which the discount monotonically increases as the predicted batching rate increases.

Also, the mapping function 315 for the time slot having the 6-hour duration has the largest discounts, while the mapping function 305 for the time slot having the 2-hour duration has the smallest discounts, to provide larger discounts to larger time windows.

Further, in each of the mapping functions 305, 310 and 315, when a predicted batching rate is low (e.g., less than 0.3), the discount is at or close to a predetermined minimum value. When the predicted batching is high (e.g., greater than or equal to 0.8), the discount for the mapping functions 305, 310 and 315 are respectively at or close to predetermined maximum values.

Referring again to FIG. 2, the architecture 200 may determine a final delivery fare by, e.g., the following equation:

$$Final Fare = Predicted Fare * ( 1 - Discount ) \qquad ( 3 )$$

The architecture 200 may further control a device (e.g., the smartphone 105 of FIG. 1) to display the determined final delivery fare via, e.g., a display such as a smartphone screen. Based on the user selecting the final delivery fare displayed with the available time slot (e.g., the scheduled delivery), the device may highlight the displayed final delivery fare and available time slot, and may control a server (e.g., the server 115 of FIG. 1) to initiate the scheduled delivery (e.g., by controlling the delivery vehicles 111 in the communication arrangement 100 of FIG. 1).

In summary, the dynamic discount system may accurately predict a delivery fare of a scheduled delivery that is days ahead and a batching possibility of the scheduled delivery. The dynamic discount system can further provide an optimized discount based on the predicted batching possibility with a flexible manner.

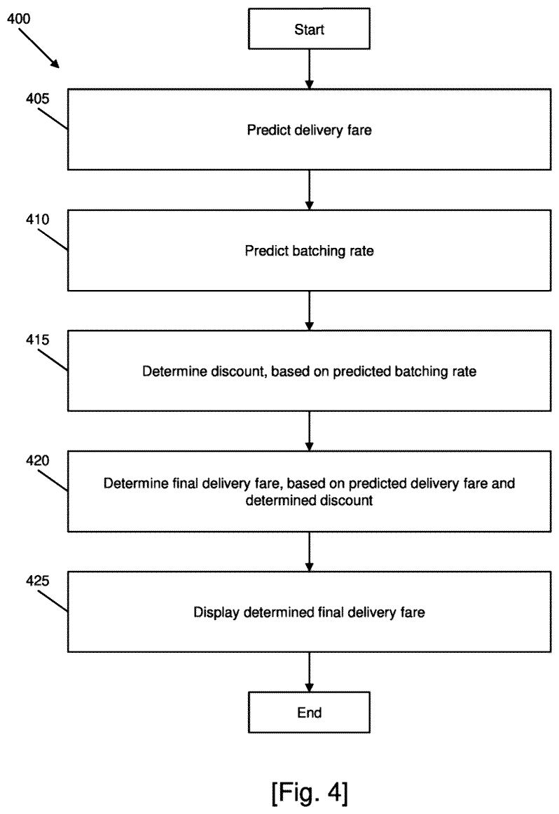

FIG. 4 shows a flow diagram of a method 400 for forecasting a delivery fare and determining a batching possibility prediction-based dynamic discount for a scheduled order of a goods delivery service, according to embodiments.

In operation 405, the method 400 includes predicting a delivery fare for a scheduled delivery in an available time slot.

In operation 410, the method 400 includes predicting a batching rate for the scheduled delivery to be batched with at least one other order in the available time slot.

In operation 415, the method 400 includes determining a discount for the scheduled delivery in the available time slot, based on the predicted batching rate.

In operation 420, the method 400 includes determining a final delivery fare for the scheduled delivery in the available time slot, based on the predicted delivery fare and the determined discount.

In operation 425, the method 400 includes displaying the determined final delivery fare for user selection of the scheduled delivery.

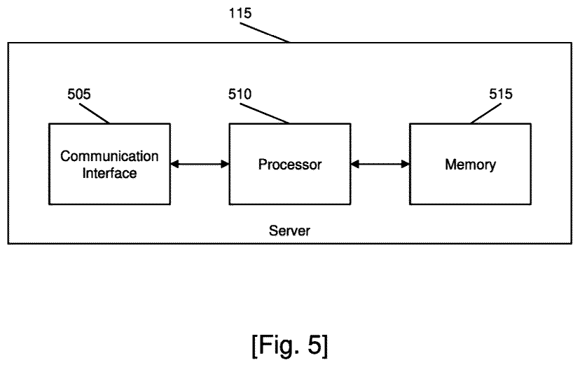

The method 400 of FIG. 4 is, for example, carried out by the server 115 as illustrated in FIG. 5.

FIG. 5 shows a block diagram of the server 115 of FIG. 1, implementing the architecture 200 of FIG. 2.

Referring to FIG. 5, the server 115 may be a server computer that includes a communication interface 505, a processor 510 and a memory 515.

The communication interface 505 may serve as a hardware and/or software interface that can, for example, transfer commands and/or data between a user and/or external devices and other components of the server 115. The communication interface 505 may further set up communication between the server 115 and the external devices, such as the smartphone 105 of FIG. 1. The communication interface 505 may be connected with a network through wireless or wired communication architecture to communicate with the external devices. The communication interface 505 may be a wired or wireless transceiver or any other component for transmitting and receiving signals.

The processor 510 may include one or more of a CPU, a graphics processor unit (GPU), an accelerated processing unit (APU), a many integrated core (MIC), a field-programmable gate array (FPGA), and/or a digital signal processor (DSP). The processor 510 may be a general-purpose controller that performs control of any one or any combination of the other components of the server 115, and/or performs an operation or data processing relating to communication. The processor 510 may execute one or more programs stored in the memory 515.

The memory 515 may include a volatile and/or non-volatile memory. The memory 515 stores information, such as one or more of commands, data, programs (one or more instructions), applications, etc., which are related to at least one other component of the server 115 and for driving and controlling the server 115. For example, commands and/or data may formulate an operating system (OS). Information stored in the memory 515 may be executed by the processor 510. The memory 515 may further store information that is executed by the processor 510 to perform functions and operations described with respect to FIGS. 1-4 above.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g., a microprocessor. A “circuit” may also be software being implemented or executed by a processor, e.g., any kind of computer program, e.g., a computer program using a virtual machine code. Any other kind of implementation of the respective functions that are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes that come within the meaning and range of equivalency of the claims are therefore intended to be embraced.

1. A method for forecasting a delivery fare and determining a batching possibility prediction-based dynamic discount for a scheduled order of a goods delivery service, the method comprising:
predicting a delivery fare for a scheduled delivery in an available time slot; predicting a batching rate for the scheduled delivery to be batched with at least one other order in the available time slot;
determining a discount for the scheduled delivery in the available time slot, based on the predicted batching rate;
determining a final delivery fare for the scheduled delivery in the available time slot, based on the predicted delivery fare and the determined discount; and displaying the determined final delivery fare for user selection of the scheduled delivery.

2. The method of claim 1, wherein the predicting the delivery fare comprises:
obtaining coordinates of an origin for the scheduled delivery, coordinates of a destination for the scheduled delivery, the available time slot, a base fare or tier base fare for the scheduled delivery, and a surge rate range; and
predicting the delivery fare for the scheduled delivery in the available time slot, based on the obtained coordinates of the origin, the obtained coordinates of the destination, the obtained available time slot, the obtained base fare or tier base fare and the obtained surge rate range.

3. The method of claim 1, wherein the delivery fare is predicted using at least one among quantile regression, linear regression, lasso regression, support vector regression, a multilayer perceptron neural network, a long short-term memory neural network, and a decision tree-based algorithm.

4. The method of claim 3, wherein each of the quantile regression neural networks comprises a multiple hidden layer feedforward neural network that is trained with historical data and a quantile loss.

5. The method of claim 1, wherein the predicting the batching rate comprises:
obtaining coordinates of an origin for the scheduled delivery, coordinates of a destination for the scheduled delivery, the available time slot, a number of completed orders in an area of the scheduled delivery and during the same time slot as the available time slot in a prior week, and a batching rate of the completed orders; and predicting the batching rate for the scheduled delivery to be batched with the at least one other order in the available time slot, based on the obtained coordinates of the origin, the obtained coordinates of the destination, the obtained available time slot, the obtained number of the completed orders and the obtained batching rate of the completed orders.

6. The method of claim 5, wherein the predicting the batching rate further comprises determining a bearing for the scheduled delivery, the bearing representing a direction between the origin and the destination for the scheduled delivery, and
the batching rate for the scheduled delivery to be batched with the at least one other order in the available time slot is predicted further based on the determined bearing.

7. The method of claim 6, wherein the predicting the batching rate further comprises determining the number of the completed orders in the area of the scheduled delivery, having the determined bearing, and during the same time slot as the available time slot in the prior week, and determining the batching rate of the completed orders, and
the batching rate for the scheduled delivery to be batched with the at least one other order in the available time slot is predicted further based on the determined number of the completed orders and the determined batching rate of the completed orders.

8. The method of claim 5, wherein the predicted batching rate is low, based on the available time slot comprising non-peak hours, and
the predicted batching rate is high, based on the available time slot comprising peak hours.

9. The method of claim 1, wherein the batching rate is predicted using a neural network with long short-term memory (LSTM) layers that is trained with historical data.

10. The method of claim 1, wherein the determining the discount comprises:
obtaining the predicted batching rate, coordinates of an origin for the scheduled delivery, coordinates of a destination for the scheduled delivery, the available time slot, a distance of the scheduled delivery, and a duration of the scheduled delivery; and determining the discount for the scheduled delivery in the available time slot, based on the obtained predicted batching rate, the obtained coordinates of the origin, the obtained coordinates of the destination, the obtained available time slot, the obtained distance of the scheduled delivery, and the obtained duration of the scheduled delivery.

11. The method of claim 10, wherein the discount is determined using an S-shaped sigmoid function having the predicted batching rate as an input and the discount as an output.

12. The method of claim 11, wherein the S-shaped sigmoid function comprises:
discount=--“>+e,
b+exp^{C(oK a)}
where a, b, c, d and e are coefficients and BR is the predicted batching rate.

13. The method of claim 12, wherein each of the coefficients a, b, c, d and e is a function of a length of the available time slot.

14. The method of claim 10, wherein the determined discount is small, based on the available time slot being short, and
the determined discount is large, based on the available time slot being long.

15. The method of claim 10, wherein the determined discount is a preset minimum value, based on the predicted batching rate being less than a predetermined minimum value, and
the determined discount is a preset maximum value, based on the predicted batching rate being greater than or equal to a predetermined maximum value.

16. The method of claim 1, wherein the final delivery fare is determined using an equation comprising:
Final Fare==Predicted Fare*(1−Discount),
where Predicted Fare is the predicted delivery fare, and Discount is the determined discount.

17. The method of claim 1, wherein the determined final delivery fare is displayed with the available time slot on a display, and is highlighted when selected by a user.

18. A server configured to perform the method of claim 1.

19. A computer program element comprising program instructions, which, when executed by one or more processors, cause the one or more processors to perform the method of claim 1.

20. A computer-readable medium comprising program instructions, which, when executed by one or more processors, cause the one or more processors to perform the method of claim 1.
